(19) United States
(12) Patent Application Publication
(10) Pub. No.: US 2018/0230248 A1
(43) Pub. Date: Aug. 16, 2018

(54) CHLORINATED VINYL CHLORIDE RESIN PRODUCTION METHOD

(71) Applicant: Kaneka Corporation, Osaka (JP)

(72) Inventor: Junichi Hirota, Hyogo (JP)

(73) Assignee: Kaneka Corporation, Osaka (JP)

(21) Appl. No.: 15/953,097

(22) Filed: Apr. 13, 2018

Related U.S. Application Data
(63) Continuation of application No. PCT/JP2016/080402, filed on Oct. 13, 2016.

(30) Foreign Application Priority Data
Oct. 15, 2015 (JP) 2015-203961
Dec. 2, 2015 (JP) 2015-235765

(51) Int. Cl. C08F 8/22; C08J 3/28

(52) U.S. Cl. CPC C08F 8/22; C08J 2327/24; C08J 3/28

(57) ABSTRACT

A method for producing chlorinated polyvinyl chloride includes placing polyvinyl chloride in a powder form in a reactor; introducing chlorine gas into the reactor, wherein the chlorine gas is brought into contact with polyvinyl chloride; irradiating the polyvinyl chloride with UV light The UV light has a wavelength ranging from 280 to 420 nm and an irradiation intensity in a range of 0.0005 to 7.0 W per kg of the polyvinyl chloride.

### TECHNICAL FIELD

One or more embodiments of the present invention relate to a method for producing chlorinated polyvinyl chloride. Particularly one or more embodiments of the present invention relate to a method for producing chlorinated polyvinyl chloride including bringing chlorine gas into contact with a powder of polyvinyl chloride and irradiating it with UV light to perform a chlorination reaction

### BACKGROUND

As polyvinyl chloride is chlorinated, it has a higher heat resistant temperature than that of polyvinyl chloride. Therefore, chlorinated polyvinyl chloride is used in various fields such as heat-resistant pipes heat-resistant industrial boards, heat-resistant films, and heat-resistant sheets.

In general, a water suspension method has been used for synthesizing chlorinated polyvinyl chloride, the method including suspending polyvinyl chloride particles in an aqueous medium to obtain an aqueous suspension and chlorinating polyvinyl chloride while supplying chlorine thereto. The water suspension method has various advantages such as easy stirring and mixing of particles, easy reaction control due to the use of low concentration chlorine dissolved in water, and easy penetration of chlorine into polyvinyl chloride, with the resin being plasticized by water.

However, in the reaction for producing chlorinated polyvinyl chloride using polyvinyl chloride and chlorine, hydrogen chloride is by-produced as Shown in the following formula. Therefore, in the case of the water suspension method, chlorinated polyvinyl chloride is in a state of being suspended in a high concentration hydrochloric acid solution after completion of the reaction.

[Chemical Formula 1]

(CH₂—CHCl)ₙ+mCl₂→(CH₂—CHClₙ₋ₘ(CHCl—CHCl)ₘ+mHCl (1)

Usually, since chlorinated polyvinyl chloride is shipped in powder form, it is necessary to remove hydrogen chloride as an impurity, and an aqueous suspension of chlorinated polyvinyl chloride obtained after a chlorination reaction is required to be dehydrated, washed with water; and dried. As a whole process therefore, a large equipment cost and a running cost accompanying drying and washing with water are required for the post-treatment process. Moreover, since water and hydrogen chloride are in an azeotropic state, hydrogen chloride cannot be removed from the product until eventually it is completely dried.

Therefore, Patent Documents 1 to 4 propose a method for synthesizing chlorinated polyvinyl chloride, the method including bringing a powder of polyvinyl chloride and chlorine into contact to react with each other.

### PRIOR ART DOCUMENTS

### Patent Documents

[Patent Document 1] JP2002-275213A

[Patent Document 2] JP2002-308930A

[Patent Document 3] JP2002-317010A

[Patent Document 4] JP2002-317011A

### SUMMARY

In Patent Documents 1 to 4, a photochlorination method is used to improve productivity of chlorinated polyvinyl chloride but in the case of such a photochlorination method, the quality, such as static thermal stability, of chlorinated polyvinyl chloride may be impaired.

One or more embodiments of the present invention provide a method for producing chlorinated polyvinyl chloride, the method including bringing chlorine gas into contact with a powder of polyvinyl chloride and irradiating it with UV light to perform a chlorination reaction and thereby obtaining chlorinated polyvinyl chloride with a high static thermal stability.

One or more embodiments of the present invention relate to a method for producing chlorinated polyvinyl chloride the method including bringing chlorine gas into contact with polyvinyl chloride and irradiating it with UV light to perform a chlorination reaction, the polyvinyl chloride being in powder form and in contact with the chlorine gas, and in the UV light, UV light in the wavelength range of 280 to 420 nm having an irradiation intensity in the range of 0.0005 to 7.0 W per kg of the polyvinyl chloride.

In one or more embodiments, the average concentration, from the start time to the end time of the chlorination reaction, of the chlorine gas inside a reactor for performing the chlorination reaction is 50% or more.

In one or more embodiments, the powder of polyvinyl chloride has a mean particle of 25 to 2500 μm.

In one or more embodiments, the powder of the polyvinyl chloride is fluidized in the reactor for performing the chlorination reaction. In one or more embodiments, the chlorination reaction is performed using a fluidized bed reactor.

In one or more embodiments, the irradiation with the UV light is performed using at least one light source selected from the group consisting of a low-pressure mercury lamp, a high-pressure mercury lamp, a metal halide lamp, a UV LED, an organic EL, and an inorganic EL.

The production method of one or more embodiments of the present invention makes it possible to obtain chlorinated polyvinyl chloride having a good static thermal stability.

### BRIEF DESCRIPTION OF THE DRAWINGS

FIG. 1 is a schematic cross-sectional side view of an apparatus for producing chlorinated polyvinyl chloride as an example used in one or more embodiments of the present invention.

FIG. 2 is a graph showing the relationship between the irradiation intensity of the UV light per kg of polyvinyl chloride and the static thermal stability of the resultant chlorinated polyvinyl chloride in Examples 1 to 3 and 6 to 11 as well as Comparative Examples 1 and 2.

FIG. 3 is a schematic cross-sectional side view of an apparatus for producing chlorinated polyvinyl chloride as an example used in one or more embodiments of the present invention.

FIG. 4 is a schematic cross-sectional side view of an apparatus for producing chlorinated polyvinyl chloride used in Comparative Example 3.

FIG. 5 is a schematic cross-sectional side view of an apparatus for producing chlorinated polyvinyl chloride used in Comparative Example 4.

FIG. 6 is a schematic explanatory view illustrating a gas path in an apparatus for producing chlorinated polyvinyl chloride as an example used in one or more embodiments of the present invention.

FIG. 7 is a graph showing the relative spectral responsivity of sensors in the UV power meter (Controller: C9536-02, Sensor: H9958-02, manufactured by Hamamatsu Photonics K.K.) used for measuring the irradiation intensity of the UV light in one or more embodiments of the present invention.

### DETAILED DESCRIPTION OF THE EMBODIMENTS

The inventor of the present application has found that when in the UV light, UV light in the wavelength range of 280 to 420 nm had an irradiation intensity set within a predetermined range, it was possible to achieve a good static thermal stability of chlorinated polyvinyl chloride while promoting the chlorination reaction by UV light irradiation.

In one or more embodiments of the present invention, it is important that the irradiation intensity of the UV light in the wavelength range of 280 to 420 nm during the chlorination reaction of poly chloride is 0.0005 to 7.0 W per kg of the polyvinyl chloride (that is, 0.0005 to 7.0 W/kg). In the present specification, unless otherwise specified the “irradiation intensity of the UV light” means the irradiation intensity of the UV light in the wavelength range of 280 to 420 nm. When the irradiation intensity of the UV light per kg of the polyvinyl chloride is within the above-mentioned range, irradiation with the UV light accelerates the chlorination reaction to improve productivity, and chlorinated polyvinyl chloride having a good static thermal stability is obtained. The irradiation intensity of the UV light per kg of the polyvinyl chloride may be 5.0 W or less, 2.5 W or less, or 1.5 W or less. On the other hand, from the viewpoint of shortening the reaction time of the chlorination reaction, the irradiation intensity of the UV light per kg of the polyvinyl chloride may be 0.001 W or more, 0.005 W or more, 0.01 W or more, 0.05 W or more, or 0.10 W or more. From the viewpoint of static thermal stability, it maybe 0.0005 W to 7.0 W, 0.0005 W to 5.0 W 0.0005 W to 3 W, 0.0005 W to 1.5 W, 0.0005 W to 1.0 W, 0.0005 W to 0.5 W, 0.001 W to 0.30 W, 0.005 W to 0.20 W or 0.008 W to 0.12 W. Overall, the irradiation intensity of the UV light per kg of the polyvinyl chloride maybe 0.1 W to 1.5 W, 0.1 W to 1.0 W or 0.2 W to 0.5 W. In one or more embodiments of the present invention, the irradiation intensity of the UV light per kg of the polyvinyl chloride is measured and calculated as described later.

In the chlorination reaction of one or more embodiments of the present invention, chlorine gas is brought into contact with a powder of polyvinyl chloride. In one or more embodiments of the present invention, the particle size of the powder of polyvinyl chloride is not particularly limited, but from the viewpoint of enhancing the fluidity of the powder and the viewpoint of uniformly promoting the chlorination reaction, the mean particle size may be, for example, 25 to 2500 μm, or 35 to 1500 μm. The particle size distribution of the powder of polyvinyl chloride is also not particularly limited, but from the viewpoint of enhancing the fluidity of the powder and the viewpoint of uniformly promoting the chlorination reaction, it may be 0.01 to 3,000 μm, or in the range of 10 to 2000 μm. In one or more embodiments of the present invention, after the powder of polyvinyl chloride was dispersed in water, a laser diffraction/scattering particle size is distribution analyzer (LA-950, manufactured by HORIBA) was used to measure the mean particle size and the particle size distribution, with the refractive index being set at 1.54. In one or more embodiments of the present specification, the powder of polyvinyl chloride supplied into a reactor for performing a chlorination reaction is also refereed to as a powder layer. Hereinafter, unless otherwise specified, the term “reactor” denotes a reactor for performing a chlorination reaction

The polyvinyl chloride may be a homopolymer of vinyl chloride monomers or maybe a copolymer of a vinyl chloride monomer and another copolymerizable monomer. Examples of another copolymerizable monomer include, but are not limited to, ethylene, propylene, vinyl acetate, allyl chloride, allyl glycidyl ether, acrylate ester, and vinyl ether.

The polyvinyl chloride may be a powder and the method of producing it is not particularly limited. For example, it may be obtained by any one of the methods such as a suspension polymerization method, a bulk polymerization method, a gas phase polymerization method, and an emulsion polymerization method. Furthermore, it maybe possible that the polyvinyl chloride be adjusted so as to fall within the above-mentioned particle size range before the chlorination reaction.

Chlorine used in one or more embodiments of the present invention is not particularly limited as long as it is chlorine that is generally used industrially. Chlorine may be diluted with a gas other than chlorine in order to adjust the reaction rate and reaction temperature of the chlorination reaction, but it maybe possible to dilute chlorine with an inert gas such as nitrogen or argon.

In one or more embodiments of the present invention, the state of chlorine that is supplied to the reactor for the chlorination reaction maybe gas or liquid. Chlorine that is generally used industrially is liquid chlorine contained in a high pressure cylinder. When chlorine is supplied as a gas liquid chlorine taken out from a liquid chlorine cylinder maybe vaporized in a separate container and then supplied to the reactor. When liquid chlorine is supplied to the reactor, the liquid chlorine supplied from a liquid chlorine cylinder may be vaporized in the reactor. The method in which chlorine is vaporized in the reactor maybe used since it provides an effect of taking the heat of reaction by the heat of vaporization to relax the temperature rise in the reaction apparatus. From the viewpoint of preventing changes in the surface structure and internal structure of the polyvinyl chloride, it is necessary to vaporize the liquid chlorine in the reactor and then bring it into contact with the polyvinyl chloride. During the chlorination reaction, chlorine maybe supplied continuously or may be supplied intermittently.

In one or more embodiments of the present invention, the chlorine gas used as a raw material can be chlorine that is obtained by removing hydrogen chloride from the emission gas containing hydrogen chloride and chlorine discharged from the reactor and then returning it into the reactor through a circulation circuit, in addition to the chlorine gas which is supplied from, for example, a chlorine gas cylinder. Examples of the method for removing hydrogen chloride include a method in which the emission gas is passed through an absorption bottle containing an absorption liquid and thereby the absorption liquid absorbs hydrogen chloride and a method in which the emission gas is passed through a general emission gas washing tower such as a packed tower or a spray tower and thereby an absorption liquid absorbs hydrogen chloride. The absorption liquid is not particularly limited as long as it absorbs hydrogen chloride selectively, but a method, in which water is used as an absorption liquid, utilizing the property that hydrogen chloride is extremely easy to dissolve in water as compared to chlorine may be used since it is inexpensive and convenient.

In one or more embodiments of the present invention, from the viewpoint of enhancing the static thermal stability of the chlorinated polyvinyl chloride to be obtained, it may be possible that the average concentration, from the start time to the end time of the chlorination reaction, of the chlorine gas inside the reactor for performing the chlorination reaction thereinafter also referred to simply as the “average concentration of the chlorine gas in the chlorination reaction”) be 50% or more. In one or more embodiments, the average concentration of the chlorine gas in the chlorination reaction maybe 60% to 100%, 65% to 100%, 80% to 100%, 85% to 100%, 90% to 100%, or 95% to 100%. Furthermore, when the average concentration of the chlorine gas in the chlorination reaction is adjusted within the range described above, chlorinated polyvinyl chloride having a high Izod impact strength can be obtained.

In one or more embodiments of the present invention, the average concentration, from the start time to the end time of the chlorination reaction, of the chlorine gas inside the reactor for is performing the chlorination reaction is measured and calculated as follows.

(1.) The chlorine concentration (vol %) and hydrogen chloride concentration (vol %) in the gas supplied to the reactor are measured every 0.1% from the time when the chlorination reaction rate is 0.1% to the end time of the reaction. In one or more embodiments of the present inventions, the phrase “measured every 0.1% form the time when the chlorination reaction rate is 0.1% to the end time of the reaction” means that if the reaction rate at the end time of the reaction contains a fraction of less than 0.1%, for example, 54.25%, it is measured up to 54.2% and the fraction is ignored. The chlorination reaction rate in one or more embodiments of the present invention is measured as described later.

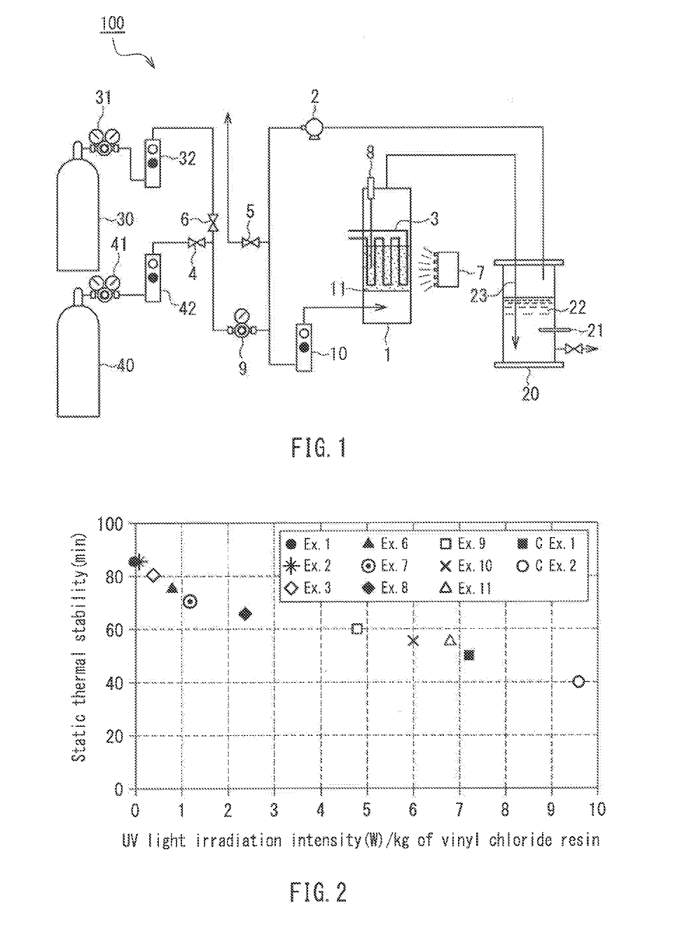

(a) As in the case ofusing the reaction apparatus shown in FIG. 1, when hydrogen chloride is removed from the gas discharged from the reactor and then chlorine gas is returned into the reactor through a circulation circuit to be used, the procedure is as follows. The chlorine concentration (vol %) and hydrogen chloride concentration (vol %) in the circulation circuit before the start of the reaction are taken as the chlorine concentration (vol %) and hydrogen chloride concentration (vol %) in the gas supplied to the reactor, respectively. The atmosphere inside the circulation circuit is replaced beforehand with a gas containing chlorine before the start of the reaction. In the case of FIG. 1, when it is replaced with chlorine gas of 100 vol %, a chlorine supply valve 6 and an exhaust valve 5 are opened, and when it is replaced with chlorine gas diluted with nitrogen gas, the chlorine supply valve 6, a nitrogen supply valve 4, and the exhaust valve 5 are opened. At this time, from the ratio of the volumetric flow rates (Nm³/min, expressed in terms of the standard state at 0° C. and 1 atm) of chlorine gas and nitrogen gas supplied into the circulation circuit, the chlorine concentration (vol %) and nitrogen concentration (vol %) inside the circulation circuit are calculated. Hereinafter, in the present specification, unless otherwise specified, the volumetric flow rate is expressed in terms of the standard state at 0° C. and 1 atm. Usually, hydrogen chloride is not supplied, and therefore the concentration is 0 (vol %). However, if it is supplied, the concentration is calculated similarly from the ratio of the volumetric flow rates. Measurement of the volumetric flow rates is not particularly limited and a generally commercially available flowmeter maybe used. During the chlorination reaction, only the same amount of chlorine gas as that of the chlorine gas consumed is automatically added through the chlorine supply valve 6 while the internal pressure of the reactor 1 is adjusted to be a predetermined value with an internal pressure regulating valve 9. Therefore, the chlorine concentration and hydrogen chloride concentration in the gas that is supplied to the reactor is during the chlorination reaction are always kept at the same values as those of the concentrations inside the circulation circuit before the start of the reaction. Furthermore, when chlorine is supplied as a liquid rather than a gas into the reactor or circulation circuit, it is considered to be equivalent to the case of supplying chlorine gas at the volumetric flow rate obtained when all the liquid chlorine is vaporized, from the supply rate of the liquid chlorine.

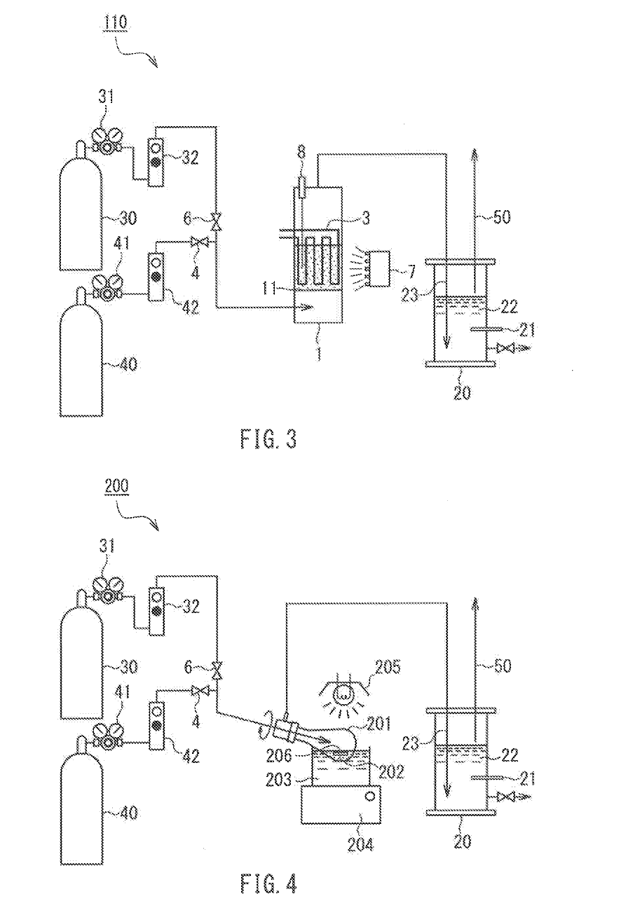

(b) When a chlorine-containing gas is supplied to the reactor in one path as in the case of using the reaction apparatus shown in FIGS. 3, 4, or 5, or as shown in FIG. 6, when a part of the emission gas discharged from the reactor is withdrawn and a chlorine-containing gas is replenished and returned into the reactor through the circulation circuit to be used, the procedure is as follows. The volumetric flow rate (Nm³/min, expressed in terms of the standard state at 0° C. and 1 atm) of each supply gas component supplied to the reactor or circulation circuit is measured every 0.1% from the time when the chlorination reaction rate is 0.1% to the end time of the reaction and the chlorine concentration (vol %) and hydrogen chloride concentration (vol %) in the supply gas are obtained from the flow rate ratio. For example, when the flow rates of the chlorine gas and nitrogen gas supplied to the reactor or circulation circuit each am 0.5 Nm³/min the chlorine concentration and nitrogen concentration in the supply gas each are 50 (vol %) and the hydra wen chloride concentration is 0 (vol %). Measurement of the volumetric flow rate is not particularly limited and a generally commercially available flowmeter may be used. Furthermore, when chlorine is supplied as a liquid rather than a gas, it is considered to be equivalent to the case of supplying chlorine gas at the volumetric flow rate obtained when all the liquid chlorine is vaporized, from the supply rate of the liquid chlorine.

(2) The hydrogen chloride concentration (vol %) in the gas discharged from the reactor for performing the chlorination reaction is measured every 0.1% from the time when the chlorination reaction rate is 0.1% to the end time of the reaction.

(a) A part or the whole amount of the gas discharged from the reactor is passed through an absorption bottle containing an absorption liquid or passed through a general emission gas washing tower such as a packed tower or a spray tower and thereby the hydrogen chloride discharged from said reactor is recovered in the absorption liquid. For example, in the case of the reaction apparatuses shown in FIGS. 1, 3, 4, and 5, a hydrogen chloride recovery container 20 corresponds thereto. In the configuration shown in FIG. 6, a part or the whole amount of the gas withdrawn from the circulation circuit is passed through a similar hydrogen chloride recovery container.

(b) From the weight (kg) of the hydrogen chloride absorbed by the hydrogen chloride recovery container and the volume (Nm³) of the gas passed through the hydrogen chloride recovery container within the time during which the chlorination reaction rate increases by 0.1%, the hydrogen chloride concentration (vol %) in the gas discharged from the reactor is obtained. For example, when the weight of hydrogen chloride recovered while the chlorination reaction rate increases by 0.1% is 10 kg, the volume of hydrogen chloride gas recovered is 6.1 Nm³ (expressed in terms of 0° C. and 1 atm) since the hydrogen chloride has a molecular weight of 36.5. When the volume of the gas discharged from the reactor is 100 Nm³ (expressed in terms of 0° C. and 1 atm), the hydrogen chloride concentration in the gas discharged from the reactor is 6.1 vol %. The weight of the hydrogen chloride absorbed by the hydrogen chloride recovery container can be calculated based on the weight of water charged beforehand as an absorption liquid in the hydrogen chloride recovery container and the hydrogen chloride concentration in the hydrogen chloride recovery container, the hydrogen chloride concentration being measured with an electric conductivity meter or a densimeter, with the water being used as the absorption liquid. Furthermore, the volume of the gas discharged from the reactor is calculated from the volumetric flow rate measured with a commercially available volumetric flowmeter made of a material that is corrosion resistant to chlorine and hydrogen chloride and the time required for the chlorination reaction rate to increase by 0.1%. Moreover, during the chlorination reaction, chlorine is consumed in the reactor and equimolar hydrogen chloride is produced. Therefore, the volumetric flow rate (Nm³/min) expressed in terms of the standard state at 0° C. and 1 atm of the gas does not change at the inlet and outlet of the reactor. Thus the volumetric flow rate of the gas discharged from the chlorination reactor may be substituted with the volumetric flow rate of the gas supplied to the reactor.

(3) From the hydrogen chloride concentration (vol %) in the gas discharged fiom the reactor determined in (2), the hydrogen chloride concentration (vol %) in the gas supplied to the reactor determined in (1) is subtracted every 0.1% from the time when the chlorination reaction rate is 0.1% to the end time of the reaction, and the result is taken as the concentration (vol %) of chlorine gas consumed in the chlorination reaction.

(4) From the chlorine concentration (vol %) in the gas supplied to the reactor determined in (1), the concentration (vol %) of chlorine gas consumed in the chlorination reaction determined in (3) is subtracted every 0.1% from the time when the chlorination reaction rate is a 0.1% to the end time of the reaction, and thereby the concentration of chlorine gas in the reactor is determined.

(5) The concentrations of chlorine gas measured every 0.1% from the time when the chlorination reaction rate is a 1% to the end time of the reaction are arithmetically averaged, and the result is taken as the average concentration, from the start time to the end time of the chlorination reaction, of chlorine gas inside the reactor for performing the chlorination reaction

In one or more embodiments of the present invention, when chlorine gas is brought into contact with a powder of polyvinyl chloride, it maybe possible that the powder of polyvinyl chloride be fluidized in the reactor for performing the chlorination reaction. In this way, the powder of polyvinyl chloride is not at rest but fluidized in the reactor for performing the chlorination reaction, which results in good contact between the gaseous chlorine and the powder particles of the polyvinyl chloride. From the viewpoint of allowing the polyvinyl chloride to be easily fluidized, it may be possible to use a fluidized bed reactor provided with a fluidized bed where a gas is allowed to flow into the powder layer to move the powder particles. In the case of using a fluidized bed, from the viewpoint of uniformly fluidizing the powder, the flow velocity of the gas to be allowed to flow may be 0.02 m/s or more, and from the viewpoint of preventing the powder from scattering, it maybe 0.5 m/s or less. A method employed in a conventionally used powder reaction apparatus other than the fluidized, bed may be used, or a method utilized in, for example, a mixing apparatus, a stirring apparatus, a combustion apparatus, a drying apparatus, a pulverizing apparatus, or a granulating apparatus maybe applied. Specifically, an apparatus of a container rotating type such as a horizontal cylindrical type, a V type, a double conical type, or a swinging rotary type, or an apparatus of a mechanical stirring type such as a single shalt ribbon type, a multi shaft paddle type, a rotating plow type, a double shaft planetary stirring type, or a conical screw type maybe used. Specific shapes of these apparatuses are described in Chemical Engineering Handbook (edited by The Society of Chemical Engineers Japan, revised 6th edition, p. 876).

In one or more embodiments of the present invention, the role of UV light is to excite chlorine to generate chlorine radicals and thereby to promote a chlorine addition reaction to polyvinyl chloride. Since chlorine has a strong absorption band with respect to the UV light in the wavelength range of 280 to 420 nm, it may be possible that while the powder of polyvinyl chloride and chlorine gas are brought into contact with each other, it is irradiated with the UV light in the wavelength range of 280 to 420 nm to perform a chlorination reaction. The UV light to be emitted may contain light having a wavelength of less than 280 nm or more than 420 nm, but from the viewpoint of energy efficiency it maybe possible to use a light source that emits a large amount of UV light in the wavelength range of 280 to 420 nm as the light sour. Specific examples thereof include a low-pressure mercury lamp, a high-pressure mercury lamp, an ultra-high pressure mercury lamp, a metal halide lamp, a UV LED, an organic EL, and an inorganic EL. Furthermore, in the spectral radiant energy distribution of the light source to be used, the total of the radiant energy (J) in the wavelength range of 280 to 420 nm maybe 20% or more of the total of the radiant energy (J) in the wavelength range of 150 to 600 nm, 60% or more, 80% or more, or 100%, that is, irradiation with only the UV light in the wavelength range of 280 to 420 nm. In particular, from the viewpoint of being able to emit UV light close to a single25 wavelength with a narrow wavelength range for irradiation, the light source maybe at least one selected from the group consisting of a UV LED, an organic EL, and an inorganic EL. The light source may be placed in a protective container according to the purpose such as protection or cooling of the light source. The material for the protective container for the light source may be any material as long as it does not interfere with the irradiation with UV light from the light source. For example, materials such as quartz Pyrex (registered trademark) glass, ha at glass and soft glass can be used for the protective container for the light source. However, it may be possible to use quartz or Pyrex (registered trademark) glass in order to effectively utilize the wavelength in the UV range that is effective for the chlorination reaction. In one or more embodiments of the present invention, the chlorination reaction is initiated by irradiation with UV light and terminated by turning off the UV light. The reaction time of the chlorination reaction in one or more embodiments of the present invention is the same as the UV light irradiation time in the case of continuous irradiation with UV light during the chlorination reaction. In the case of intermittent irradiation with UV light during the chlorination reaction, the reaction time of the chlorination reaction as described herein is the sum of the time during which UV light is emitted and the time during which it is turned off but the chlorination reaction itself proceeds only during actual irradiation with UV light.

In one or more embodiments of the present invention, the light source for emitting UV light is not limited as long as it can irradiate polyvinyl chloride with UV light. The number thereof also is not limited and one light source maybe used but a plurality of light sources can also be used. Furthermore, the method for installing the light source is riot particularly limited. It may be placed outside the reactor, maybe placed inside the reactor; or may be placed both outside and inside the reactor. When the light source is installed inside the reactor, the whole or a part of the light source may be inserted into the powder layer of polyvinyl chloride. From the viewpoint of preventing corrosion due to chlorine, it maybe possible to install the light source inside the reactor, with the light source being placed in a protective container. For example, when the reactor for performing the chlorination reaction has a small size, irradiation with UV light from the outside of the powder layer or the outside of the reactor makes it easy to provide a large light receiving area of the polyvinyl chloride and therefore is efficient. On the other hand, when the reactor is enlarged in order to perform the chlorination reaction on a commercial scale, from the viewpoint of efficiently irradiating the polyvinyl chloride with UV light, it may be possible to insert a light source into the powder layer, and it maybe possible to use two or more light sources inserted into the powder layer.

The temperature in the reactor for performing the chlorination reaction of the polyvinyl chloride is not particularly limited, but it maybe 10 to 100° C., or 25 to 85° C. from the viewpoint of preventing the polyvinyl chloride from deteriorating and the chlorinated polyvinyl chloride from being colored while facilitating the fluidization of the polyvinyl chloride. Since the chlorination reaction of the polyvinyl chloride is an exothermic reaction, it maybe possible to remove the heat of the powder layer and keep the temperature inside the reactor within the above-mentioned range. Heating or removing the heat of the powder layer can be carried out, for example, by passing hot water or cooling water through a heat transfer tube placed inside the reactor.

The chlorinated polyvinyl chloride obtained by the chlorination reaction described above often contains unreacted chlorine and by-product hydrogen chloride inside the particles and/or on the surfaces of the particles. Therefore, it may be possible to remove chlorine and hydrogen chloride. Examples of a method for removing chlorine and hydrogen chloride include an air stream cleaning method in which chlorinated polyvinyl chloride is stirred or a fluidized bed is formed in a container in which a gas such as nitrogen, air, argon, or carbon dioxide is allowed to flow, and a vacuum degassing method in which a container containing chlorinated polyvinyl chloride is vacuum-degassed and thereby chlorine and hydrogen chloride are removed.

Hereinafter, the description will be made with reference to the drawings. In one or more embodiments of the present invention, using a reaction apparatus shown in FIG. 1, the chlorination reaction is performed under irradiation with UV light, with chlorine gas being brought into contact with a powder of polyvinyl chloride, and thereby chlorinated polyvinyl chloride can be produced. First, a fluidized bed reactor 1 (a cylindrical type having a diameter of 80 mm)) made of Pyrex (registered trademark) glass is filled with polyvinyl chloride (powder) 11. Next, a circulation pump 2 is started to fluidize the polyvinyl chloride 11. The circulation flow rate is not particularly limited as long as it can fluidize the polyvinyl chloride. From the viewpoint of uniformly fluidizing the powder, the flow velocity inside the reactor 1 maybe 0.02 m/s or more. From the viewpoint of preventing the powder from scattering it may be 0.5 m/s or less. Therefore, the range of the circulation flow rate maybe 6.0 to 150.7 L/min. The circulation flow rate can be measured with a circulation flowmeter 10. Thereafter, the temperature of the polyvinyl chloride 11 is adjusted to, for example, 40 to 60° C. with a heat transfer tube 3 inserted into the reactor 1. Subsequently while a nitrogen supply valve 4 and an exhaust valve 5 are opened to adjust the internal pressure of the reactor 1 to be, for example, 30 to 50 kPa, or 0 to 30 kPa, the atmosphere inside the reactor 1 is replaced with 100 vol % of nitrogen. Thereafter, while the nitrogen supply valve 4 is closed and a chlorine supply valve 6 is opened to adjust the internal pressure of the reactor 1 to be, for example, 30 to 50 kPa, or 0 to 30 kPa, the atmosphere inside the reactor 1 is replaced with 100 vol % of chlorine gas. Chlorine is supplied from a chlorine gas cylinder 30 equipped with a pressure regulator 31, and the flow rate of the chlorine is measured with a flowmeter 32. Nitrogen is supplied from a nitrogen gas cylinder 40 equipped with a pressure regulator 41 and the flow rate of the nitrogen is measured with a flowmeter 42. The gas discharged through the exhaust valve 5 is treated in a chlorine removing equipment (not shown). Subsequently, a light source 7 installed at a predetermined position outside the reactor 1 is turned on to irradiate the surface of the powder layer with UV light and thereby a chlorination reaction is performed. The irradiation intensity of the UV light per kg of the polyvinyl chloride should be in the range of 0.0005 to 7 W. The irradiation intensity of the UV light per kg of the polyvinyl chloride can be adjusted by the area of the UV light irradiation region of the polyvinyl chloride, the irradiation intensity per unit area of the UV light, and the total weight of the polyvinyl chloride used as the raw material. As the chlorination reaction starts, the temperature of the powder layer rises due to the reaction heat, but the temperature inside the reactor 1 is continuously measured with a thermocouple 8 installed in the powder layer to be adjusted. For adjusting the temperature, for example, cooling water may be passed through the heat transfer tube 3 to adjust the temperature inside the reactor 1. An emission gas 23 containing hydrogen chloride and chlorine discharged from the outlet of the reactor 1 is passed through a hydrogen chloride absorption vessel 20 charged with water 22, the hydrogen chloride is absorbed by the water 22, and the chlorine gas is circulated through a circulation circuit to be returned to the reactor 1. The same amount of chlorine gas as that of the chlorine gas consumed in the chlorination reaction can be automatically added through the chlorine supply valve 6 while the internal pressure of the reactor 1 is adjusted to be a predetermined value with an internal pressure regulating valve 9. When the chlorination reaction rate reaches a predetermined value, the light source 7 is turned off and thereby the chlorination reaction is terminated. After completion of the chlorination reaction, the flow of the chlorine gas is stopped, the nitrogen supply valve 4 and the exhaust valve 5 are opened, the atmosphere inside the reactor 1 is replaced with nitrogen, and then the chlorinated polyvinyl chloride is taken out.

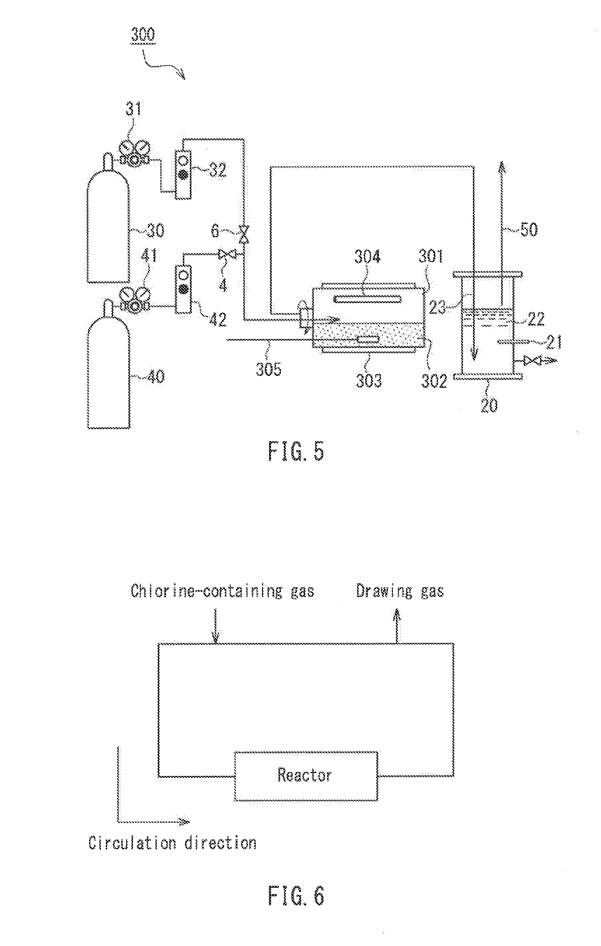

In one or more embodiments of the present invention, a reaction apparatus shown in FIG. 3 may be used. The reaction apparatus 110 shown in FIG. 3 has the same configuration as that of the reaction apparatus 100 shown in FIG. 1 except that it does not have a circulation circuit for returning chlorine gas 50 contained in the gas discharged horn a reactor to the reactor 1. Specifically, the reaction apparatus 110 shown in FIG. 3 has the same configuration as that of the reaction apparatus 100 shown in FIG. 1 except that it does not include the circulation pump 2, the exhaust valve 5, the internal pressure regulating valve 9, and the circulation flowmeter 10. In one or more embodiments of the present invention, reaction apparatuses shown in FIGS. 4 and 5 may be used. The reaction apparatus 200 shown in FIG. 4 and the reaction apparatus 300 shown in FIG. 5 each have the same configuration as that of the reaction apparatus 110 shown in FIG. 3 except that the reactor is different.

In one or more embodiments of the present specification, the chlorination reaction rate is considered to be 100% when 1 mol (62.5 g) ofpolyvinyl chloride and 1 mol (71 g) of chlorine are reacted to each other to produce 1 mol (97 g) of chlorinated polyvinyl chloride and 1 mole (36.5 g) of hydrogen chloride. The chlorination reaction rate of 53% denotes that 37.63 g (0.53 mol) of chlorine reacts with 62.5 g (1 mol) of polyvinyl chloride and thereby 80.785 g of chlorinated polyvinyl chloride and 19.345 g of hydrogen chloride are produced. The chlorination reaction rate is calculated based on the weight of hydrogen chloride generated during the chlorination reaction, which is measured, and the weight of the polyvinyl chloride used for the chlorination reaction. Hydrogen chloride produced during the chlorination reaction is absorbed by a predetermined amount of water, the hydrogen chloride concentration in the aqueous solution thus obtained is measured with an electric conductivity meter or densimeter and based on the hydrogen chloride concentration and the weight of the water, the weight of the hydrogen chloride generated during the chlorination reaction can be calculated.

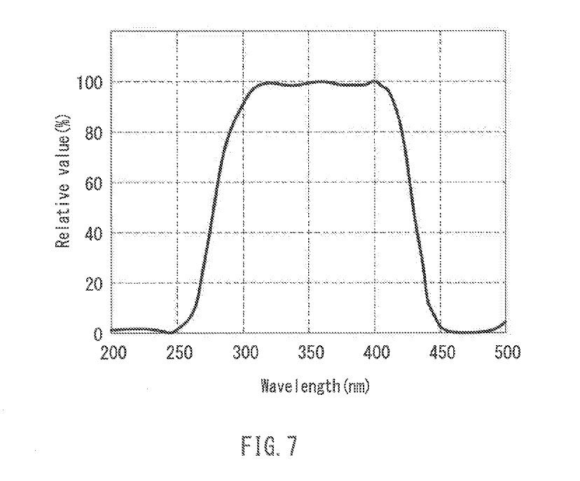

In one or more embodiments of the present invention, the “irradiation intensity of the UV light per kg of the polyvinyl chloride” is measured and calculated as follows. The irradiation intensity of the UV light referred to in one or more embodiments of the present invention is the irradiation intensity in the wavelength range of 280 to 420 nm as described above. In one or more embodiments of the present invention, a UV power meter (controller: C9536-02, sensor 119958-02) manufactured by Hamamatsu Photonics K.K. is used fix the measurement of the irradiation intensity of the UV light. FIG. 7 shows the relative spectral response characteristics of the sensor (H9958-02). In one or more embodiments of the present invention, in principle, the UV power meter (controller: C9536-02, sensor: H9958-02) manufactured by Hamamatsu Photonics K.K. described above is used for the measurement of the irradiation intensity of the UV light. However, if this UV power meter cannot be obtained, for example, data measured using another instrument for measuring irradiation intensity of the UV light is corrected based on the relative spectral response characteristics of the sensor shown in FIG. 7 and thereby similarly the irradiation intensity of the UV light can be calculated.

(1) The UV light irradiation area is measured. In the case where the light source is placed outside the reactor, the region irradiated with the UV light emitted from the light source is checked at a position on the inner wall of the reactor, and the area of the region is taken as the UV light irradiation area (cm²). For example, in the case of using the apparatus shown in FIG. 1, a UV power meter (controller: C9536-02, sensor: H9958-02, manufactured by Hamamatsu Photonics K.K.) is used to check the region (the region where a UV light intensity of 10 μW/cm² or more can be detected) irradiated with the UV light emitted from a UV LED light source at a position on the inner wall of the reactor, and then the area of the region is measured. At a position on the outer surface of the light source in the case where the light source is placed inside the reactor or at a position on the outer surface of a protective container for the light source when the light source is disposed inside the protective container; the region irradiated with the UV light emitted from the light source is checked and the area of the region is taken as the UV light irradiation area (cm²).

(2) The UV light irradiation area is divided into 1 cm square (1 cm²) regions and the irradiation intensity in each divided region is measured. After the UV light irradiation arm is divided into 1 cm square (1 cm²) regions, if a region of less than 1 cm² remains, the irradiation intensity of that divided region is also measured. Specifically, using a UV power meter (controller: C9536-02, sensor: H9958-02, manufactured by Hamamatsu Photonics K.K.), a sensor is placed in such a manner that the center of each divided region and the center of the sensor overlap each other, the irradiation intensity per unit area (W/cm²) of the UV light in the wavelength range of 280 to 420 nm is measured, and the arithmetic mean value of the irradiation intensities of all the divided regions is taken as the irradiation intensity per unit area in the present invention. For example, in the case of using the apparatus shown in FIG. 1, the irradiation intensity per unit area (W/cm²) of the UV light is measured for each 1 cm² region at a position on the inner wall of the reactor 1, and then the calculated average value thereof is determined. Measurement of the irradiation intensity per unit area of the UV light emitted turn the light source is performed in an air atmosphere and in a state where the inside of the reactor is empty.

(3) The value obtained by dividing the UV light irradiation area (cm²) by the total weight (kg) of the polyvinyl chloride charged as the raw material in the reactor is taken as the UV light irradiation area (cm²) per kg of the polyvinyl chloride.

(4) The value obtained by multiplying the irradiation intensity per unit area (W/cm²) of the UV light by the UV light irradiation area (cm²) per kg of the polyvinyl chloride is taken as the irradiation intensity (W) of the UV light per kg of the polyvinyl chloride.

When the light source that emits the UV light during the chlorination reaction is intermittently turned on, the irradiation intensity (W) of the UV light per kg of the polyvinyl chloride measured and calculated as described above is multiplied by the ratio of the time during which the light is turned on to the total time of the time during which the light is turned on and the time during which the light is turned off.

The chlorinated polyvinyl chloride obtained by the production method of one or more embodiments of the present invention is excellent in static thermal stability.

In one or more embodiments of the present invention, the static thermal stability of the chlorinated polyvinyl chloride is evaluated by using a sample (sheet) prepared using the chlorinated polyvinyl chloride, heating it in an oven at 200° C., and measuring the time until the sheet is blackened. The longer the time until it is blackened, the higher the static thermal stability. The details of the evaluation of the static thermal stability of the chlorinated polyvinyl chloride will be described later.

In one or more embodiments of the present invention, the Izod impact strength of the chlorinated polyvinyl chloride is measured according JIS K 7110. The details of the evaluation of the Izod impact strength of the chlorinated polyvinyl chloride will be described later.

### EXAMPLES

Hereinafter, one or more embodiments of the present invention will be described in more detail with reference to examples and comparative examples, but the present invention is not limited by them.

### Example 1

The reaction apparatus 100 shown in FIG. 1 was used. The fluidized bed reactor 1 (a cylindrical type having a diameter of 80 mm) made of Pyrex (registered trademark) glass shown in FIG. 1 was filled with 0.5 kg (8 mol) of polyvinyl chloride 11. The polyvinyl chloride 11 was a homopolymer of vinyl chloride monomers having a degree of polymerization of 1000 obtained by a suspension polymerization method and was a powder in which the particle size distribution measured with a laser diffraction/scattering type particle size distribution analyzer (LA-950 manufactured by HORIBA) was 25 to 600 μm and the mean particle size was 140 μm. The circulation pump 2 was started and the polyvinyl chloride 11 was circulated at a circulation flow rate of 90.4 L/min to be fluidized. The circulation flow rate was measured with the circulation flowmeter 10. Thereafter, the temperature of the polyvinyl chloride 11 was adjusted to 50° C. with the heat transfer tube 3 inserted into the reactor 1. Subsequently, while the nitrogen supply valve 4 and the exhaust valve 5 were opened to adjust the internal pressure of the reactor 1 to be 10 kPa, with, the atmosphere inside the reactor 1 was replaced with 100 vol % of nitrogen at a flow rate of 1 L/min for 30 minutes. Thereafter, while the nitrogen supply valve 4 was closed and the chlorine supply valve 6 was opened to adjust the internal pressure of the reactor 1 to be 10 kPa, the atmosphere inside the reactor 1 was replaced with 100 vol % of chlorine gas at a flow rate of 1 L/min for 30 minutes. Chlorine was supplied from the chlorine gas cylinder 30 equipped with the pressure regulator 31, and the flow rate of the chlorine was measured with the flowmeter 32. Nitrogen was supplied from the nitrogen gas cylinder 40 equipped with the pressure regulator 41 and the flow rate of the nitrogen was measured with the flowmeter 42.

The gas discharged through the exhaust valve 5 was treated in the chlorine removing equipment (not shown). Subsequently, the UV LED light source 7 (20 UV LED elements, NVSU233A with a peak wavelength of 365 nm, manufactured by Nichia. Corporation) placed on the side (the surface of the powder layer of the polyvinyl chloride) of the reactor 1 was turned on to irradiate the surface of the powder layer with UV light and thereby the chlorination reaction was initiated. The irradiation intensity of the UV light per kg of the poly vinyl chloride was set to be 0.01 W. Specifically, on the inner wall of the reactor 1, the UV light irradiation area was 10 cm² per kg of the polyvinyl chloride and the irradiation intensity per unit area of the UV light was 1 mW/cm². The UV light irradiation area was adjusted by partially applying a vinyl tape that did not transmit UV light onto the outer wall of the reactor 1 beforehand. After initiating the chlorination reaction the reaction was performed while the temperature inside the reactor 1 was continuously measured with the thermocouple 8 installed in the powder layer (the polyvinyl chloride 11). The temperature inside the reactor 1 was adjusted to be 70° C., with cooling water being passed through the heat transfer tube 3. The emission gas 23 containing hydrogen chloride and chlorine discharged from the outlet of the reactor 1 was passed through the hydrogen chloride absorption vessel 20 charged with 5 L of water 22 and thereby the hydrogen chloride was absorbed by the water 22. The hydrogen chloride concentration was continuously measured with an electric conductivity meter 21 (ME-112T, manufactured by DEK-TOA CORPORATION) and thereby the weight of the hydrogen chloride generated during the chlorination reaction was calculated. The chlorination reaction rate was calculated from the weight of the hydrogen chloride generated during the chlorination reaction and the weight of the polyvinyl chloride charged in the reactor 1 and thus the chlorination reaction rate was continuously obtained. The same amount of chlorine gas as that of the chlorine gas consumed in the chlorination reaction was automatically added through the chlorine supply valve 6 while the internal pressure of the reactor 1 was adjusted to be 10 kPa with the internal pressure regulating valve 9. When the chlorination reaction rate reached 53.0%, the UV LED light source 7 was turned off and thereby the chlorination reaction was terminated. After completion of the chlorination reaction, the flow of the chlorine gas was stopped, the nitrogen supply valve 4 and the exhaust valve 5 were opened, the atmosphere inside the reactor 1 was replaced with nitrogen at a flow rate of 1 L/min for 30 minutes, the chlorine gas remaining inside the reactor 1 and the chlorine and hydrogen chloride adsorbed on the resin were removed, and then the chlorinated polyvinyl chloride was taken out. The wavelength range of the UV LED (UV-LED elements, NVSU233A, manufactured by Nichia Corporation) used in this experiment is 350 to 400 nm and the total of the radiant energy of UV light of 280 to 420 nm is nearly 100% of the sum of the radiant energy of light in the wavelength range of 150 to 600 nm.

### Example 2

Chlorinated polyvinyl chloride was obtained under the same conditions as in Example 1 except that the UV light irradiation area was set to 20 cm² per kg of the polyvinyl chloride, the irradiation intensity per unit area of the UV light was set to 5 mW/cm², and thereby the irradiation intensity of the UV light per kg of the polyvinyl chloride was set to 0.10 W.

### Example 3

Chlorinated polyvinyl chloride was obtained under the same conditions as in Example 1 except that the UV light irradiation area was set to 40 cm² per kg of the polyvinyl chloride, the irradiation intensity per unit area of the UV light was set to 10 mW/cm², and thereby the irradiation intensity of the UV light per kg of the polyvinyl chloride was set to 0.40 W.

### Example 4

Chlorinated polyvinyl chloride was obtained under the same conditions as in Example 2 except that the irradiation intensity per unit area of the UV light was set to 20 mW/cm² and thereby the irradiation intensity of the UV light per kg of the polyvinyl chloride was set to 0.40 W.

### Example 5

Chlorinated polyvinyl chloride was obtained under the same conditions as in Example 3 except that the irradiation intensity per unit area of the UV light was set to 30 mW/cm², UV irradiation with the UV LED light source 7 was performed by intermittent irradiation in which turning on for one second and turning off for two seconds are repeated until the end of the chlorination reaction using an intermittent timer, and the irradiation intensity of the UV light per kg of the polyvinyl chloride was set to 0.40 W. In Example 5, the time for turning on the light source that emits UV light is ⅓ of the chlorination reaction time.

### Example 6

Chlorinated polyvinyl chloride was obtained under the same conditions as in Example 3 except that the irradiation intensity per unit area of the UV light was set to 20 mW/cm² and thereby the irradiation intensity of the UV light per kg of the polyvinyl chloride was set to 0.80 W.

### Example 7

Chlorinated polyvinyl chloride was obtained under the same conditions as in Example 3 except that the irradiation intensity per unit area of the UV light was set to 30 mW/cm² and thereby the irradiation intensity of the UV light per kg of the polyvinyl chloride was set to 1.20 W.

### Example 8

Chlorinated polyvinyl chloride was obtained under the same conditions as in Example 3 except that the irradiation intensity per unit area of the UV light was set to 60 mW/cm² and thereby the irradiation intensity of the UV light per kg of the polyvinyl chloride was set to 2.40 W.

### Example 9

Chlorinated polyvinyl chloride was obtained under the same conditions as in Example 3 except that the irradiation intensity per unit area of the UV light was set to 120 mW/cm² and thereby the irradiation intensity of the UV light per kg of the polyvinyl chloride was set to 4.80 W.

### Example 10

Chlorinated polyvinyl chloride was obtained under the same conditions as in Example 3 except that the irradiation intensity per unit area of the UV light was set to 150 mW/cm² and thereby the irradiation intensity of the UV light per kg of the polyvinyl chloride was set to 6.0 W.

### Example 11

Chlorinated polyvinyl chloride was obtained under the same conditions as in Example 3 except that the irradiation intensity per unit area of the UV light was set to 170 mW/cm² and thereby the irradiation intensity of the UV light per kg of the polyvinyl chloride was set to 6.80 W.

### Example 12

The reaction apparatus 110 shown in FIG. 3 was used. A fluidized bed reactor 1 (a cylindrical type having a diameter of 40 mm) made of Pyrex (registered trademark) glass was filled with 375 g (6mol) of polyvinyl chloride 11. As the polyvinyl chloride, the same one as used in Example 1 was used. While a nitrogen supply valve 4 was opened to allow nitrogen to flow into a reactor 1 at a flow rate of 23 L/min for 20 minutes, the temperature of the polyvinyl chloride 11 was adjusted to 50° C. with a heat transfer tube 3 inserted into the reactor 1. Thereafter, a chlorine supply valve 6 was opened, the flow rate of the nitrogen gas was set to 2.3 L/min, the flow rate of the chlorine gas was set to 20.7 L/min, and a gas (composed of 90 vol % of chlorine gas and 10 vol % of nitrogen gas) having a supply chlorine gas concentration of 90 vol % was allowed to flow into the reactor 1 for five minutes. After five minutes, a UV LED light source 7 (20 UV-LED elements, NVSU233A, with a peak wavelength of 365 nm, manufactured by Nichia Corporation) placed on the side (the surface of the powder layer of the polyvinyl chloride) of the reactor 1 was turned on to irradiate the surface of the powder layer with UV light and thereby the chlorination reaction was initiated. The irradiation intensity of the UV light per kg of the polyvinyl chloride was set to be 0.40 W. Specifically, on the inner wall of the reactor, the UV light irradiation area was 40 cm² per kg of the polyvinyl chloride and the irradiation intensity per unit area of the UV light was 10 MW/cm². The UV light irradiation area was adjusted by partially applying a vinyl tape that did not transmit IN light onto the outer wall of the reactor beforehand. After initiating the chlorination reaction, the reaction was performed while the temperature inside the reactor 1 was continuously measured with a thermocouple 8 installed in the powder layer. The temperature inside the reactor 1 was adjusted to be 70° C., with cooling water being passed through the heat transfer tube. An emission gas 23 containing hydrogen chloride and chlorine discharged from the outlet of the reactor 1 was passed through a hydrogen chloride absorption vessel 20 charged with 5 L of water 22 and thereby the hydrogen chloride was absorbed by the water. The hydrogen chloride concentration was continuously measured with an electric conductivity meter 21 (ME-112T, manufactured by DKK-TOA CORPORATION) and thereby the weight of the hydrogen chloride generated during the chlorination reaction was calculated. The chlorination reaction rate was calculated from the weight of the hydrogen chloride generated during the chlorination reaction and the weight of the polyvinyl chloride charged in the reactor and thus the chlorination reaction rate was continuously obtained. When the chlorination reaction rate reached 53.0%, the UV LED light source 7 was turned off and thereby the chlorination reaction was terminated. After completion of the reaction, the flow of the chlorine gas was stopped, and nitrogen gas was allowed to flow at a flow rate of 23 L/min for 30 minutes to replace the chlorine. Thereafter the resin was taken out and thus a sample was obtained.

### Examples 13 to 15

Chlorinated polyvinyl chloride was obtained in the same manner as in Example 12 except that the concentration of the chlorine gas to be supplied to the reactor was set as shown in Table 1.

### Example 16

Chlorinated polyvinyl chloride was obtained in the same manner as in Example 12 except that the concentration of the chlorine gas to be supplied to the reactor was set to 65 vol % (composed of 65 vol % of chlorine gas and 35 vol % of nitrogen gas) until the chlorination reaction rate reached 25%, and when the chlorination reaction rate reached 25%, the concentration of the chlorine gas to be supplied to the reactor was changed from 65 vol % to 100 vol %.

### Example 11

Chlorinated polyvinyl chloride was obtained in the same manner as in Example 12 except that the concentration of the chlorine gas to be supplied to the reactor was set to 100 vol % until the chlorination reaction rate reached 25%, and when the chlorination reaction rate reached 25%, the concentration of the chlorine gas to be supplied to the reactor was changed horn 100 vol % to 65 vol % (composed of 65 vol % of chlorine gas and 35 vol % of nitrogen gas).

### Examples 18 and19

Chlorinated polyvinyl chloride was obtained in the same manner as in Example 12 except that the concentration of the chlorine gas to be supplied to the reactor was set as shown in Table 1.

### Example 20

Chlorinated polyvinyl chloride was obtained in the same manner as in Example 8 except that a 400 W high pressure mercury lamp (product name: “Handy Cure Love 400”, model number: HLR400T-1, manufactured by SEN LIGHTS Corporation) was used instead of the UV LED light source and the UV light irradiation time was set to 80 minutes. The high-pressure mercury lamp emitted not only the UV light in the wavelength range of 280 to 420 nm but also light having wavelengths exceeding 420 nm. However, as described above, the irradiation intensity per unit area of the UV light in the wavelength range of 280 to 420 nm was taken as the irradiation intensity per unit area of the UV light to be calculated. As a result, the irradiation intensity of the UV light per kg of the polyvinyl chloride was 2.40 W in this experiment. In the spectral radiant energy distribution of the 400 W high pressure mercury lamp (product name: “Handy Cure Love 400,” model number: HLR 400T-1, manufactured by SEN LIGHTS Corporation), the total of the radiant energy of the UV light in the wavelength range of 280 to 420 nm is 51% of the sum of the radiant energy of the light in the wavelength range of 150 to 600 nm.

### Comparative Example 1

Chlorinated polyvinyl chloride was obtained under the same conditions as in Example 3 except that the irradiation intensity per unit area of the UV light was set to 180 mW/cm² and thereby the irradiation intensity of the UV light per kg of the polyvinyl chloride was set to 7.20 W.

### Comparative Example 2

Chlorinated polyvinyl chloride was obtained under the same conditions as in Example 3 except that the irradiation intensity per unit area of the UV light was set to 240 mW cm² and thereby the irradiation intensity of the UV light per kg of the polyvinyl chloride was set to 9.60 W.

### Comparative Example 3

Comparative Example 3 is a comparative example in which Example 1 of JP2002-275213A. was reexamined as follows. A reaction apparatus 200 shown in FIG. 4 was used. A reactor 201 (1 L eggplant-shaped flask made of Pyrex (registered trademark) glass) was filled with 187.5 g (3 mol) of polyvinyl chloride 202. As the polyvinyl chloride, the same one as used in Example 1 was used. The reactor 201 immersed in warm water in a thermostat tank that was kept at 60° C. while being stirred with a stirrer 204 was rotated in the direction of the arrow with a rotary evaporator (not shown). A nitrogen supply valve 4 was opened to allow nitrogen to flow into the space of the reactor 201 at a flow rate of 200 mL/min for 60 minutes. Thereafter the nitrogen supply valve 4 was closed and a chlorine supply valve 6 was opened to allow 100 vol % of chlorine gas to flow at a flow rate of 200 mL/min for 30 minutes. After 30 minutes, the flow rate of the chlorine gas was increased to 600 mL/min a 400 W high-pressure mercury lamp 205 (“Handy Cure Love 400” model number: HLR 400T-1, manufactured by SEN LIGHTS Corporation) placed at a position 35 cm away from the surface of the powder layer was turned on to irradiate the surface of the powder layer with UV light, and thereby the chlorination reaction was initiated. The chlorination reaction was performed while the temperature of the powder layer was continuously measured with a thermocouple 206 installed in the powder layer during the reaction. Since, on the inner wall of the reactor 201, the UV light irradiation area was 502 cm² per kg of the polyvinyl chloride and the irradiation intensity per unit area of the UV light was 16.7 mW/cm², the irradiation intensity of the UV light per kg of the polyvinyl chloride was 8.39 W. An emission gas 23 containing hydrogen chloride and chlorine discharged from the reactor 201 was passed through a hydrogen chloride absorption vessel 20 charged with 5 L of water 22 and thereby the hydrogen chloride was absorbed by the water. The hydrogen chloride concentration was continuously measured with an electric conductivity meter 21 (ME-112T, manufactured by DKK-TOA CORPORATION) and thereby the weight of the hydrogen chloride generated during the chlorination reaction was calculated. The chlorination reaction rate was calculated from the weight of the hydrogen chloride generated during the chlorination reaction and the weight of the polyvinyl chloride charged in the reactor and thus the chlorination reaction rate was continuously obtained. When the chlorination reaction rate reached 53.0%, the high-pressure mercury lamp 205 was turned off and thereby the reaction was terminated. After completion of the reaction, the flow of the chlorine gas was stopped, and nitrogen gas was allowed to flow at a flow rate of 600 mL/min for 100 minutes to replace the chlorine. Thereafter, the resin was taken out and thus a sample was obtained.

### Comparative Example 4

Comparative Example 4 is as comparative example in which Example 4 of JP2002-27523A was reexamined as follows. A reaction apparatus 300 shown in FIG. 5 was used. A reactor 301 (made of Hastelloy C22 and having a capacity of 10 L) shown in FIG, 5 was filled with 750 g (12 mol) of poly chloride 302. As the polyvinyl chloride, the same one as used in Example 1 was used. The reactor 301 was placed on two rubber rollers (not shown) installed in the direction parallel to the rotation axis of the reactor 301 and the rubber rollers were rotated to rotate the is reactor 301 in the direction of the arrow. While warm water at 40° C. was passed through a temperature control jacket 303 provided for the reactor 301, a nitrogen supply valve 4 was opened to allow nitrogen to flow into the reactor 301 at a flow rate of 5000 mL/min for 30 minutes. Thereafter, the nitrogen supply valve 4 was closed and a chlorine supply valve 6 was opened to allow 100 vol % of chlorine gas to flow at a flow rate of 2500 mlimin thr 30 minutes. After 30 minutes, a 100 W high-pressure mercury lamp 304 (model number “USH-103D,” manufactured by Ushio Inc.) installed inside the reactor 301 was turned on to irradiate the surface of the powder layer with UV light and thereby the chlorination reaction was initiated. The chlorination reaction was preformed while the temperature of the powder layer was continuously measured with a thermocouple 305 installed in the powder layer during the reaction. The high-pressure mercury lamp 304 was placed in a protective container made of Pyrex (registered trademark) glass having a diameter of 60 mm and a length of 300 mm. Since the irradiation area on the outer surface of the protective container for the high-pressure mercury lamp 304 was 753 cm² per kg of the polyvinyl chloride and the irradiation intensity per unit area of the UV light was 26.5 mW/cm², the irradiation intensity of the UV light per kg of the polyvinyl chloride was 20.0 W. An emission gas 23 containing hydrogen chloride and chlorine discharged from the reactor 301 was passed through a hydrogen chloride absorption vessel 20 charged with 10 L of water 22 and thereby hydrogen chloride was absorbed by the water. The hydrogen chloride concentration was continuously measured with an electric conductivity meter 21 (ME-112T, manufactured by DKK-TOA CORPORATION) and thereby the weight of the hydrogen chloride generated during the chlorination reaction was calculated. The chlorination reaction rate was calculated from the weight of the hydrogen chloride generated during the chlorination reaction and the weight of the polyvinyl chloride charged in the reactor and thus the chlorination reaction rate was continuously obtained. When the chlorination reaction rate reached 53.0%, the high-pressure mercury lamp 304 was turned off and thereby the reaction was terminated. After completion of the reaction, the flow of the chlorine gas was stopped, and nitrogen gas was allowed to flow at a flow rate of 5000 mL/cm² for 90 minutes to replace the chlorine. Thereafter, the resin was taken out and thus a sample was obtained. In the radiant energy distribution of the light emitted by the 100 W high-pressure mercury lamp (model number “USH-103D,” manufactured by Ushio Inc), the total of the radiant energy of the UV light in the wavelength range of 280 to 420 nm was 59% of the total radiant energy of the light in the wavelength range of 150 to 600 nm.

In Examples 1 to 20 and Comparative Examples 1 to 4, as described above, the average concentration, from the start time to the end time of the chlorination reaction, of the chlorine gas inside the reactor for performing the chlorination reaction was measured and calculated. The results are shown in Table 1 below. In Table 1 below, the supply chlorine gas concentration denotes the chlorine concentration in the gas supplied to the reactor, and the average chlorine concentration denotes the average concentration, from the start time to the end time of the chlorination reaction of the chlorine gas inside the reactor for performing the chlorination reaction.

The static thermal stability, Vicat softening point, and Izod impact strength of the chlorinated polyvinyl chlorides obtained in Examples 1 to 20 and Comparative Examples 1 to 4 were measured and evaluated as follows. The results are shown in Table 1 below. Table 1 below also shows the reaction conditions for the chlorination reaction. In Table 1 below, PVC denotes polyvinyl chloride, and FIG. 2 shows the results of the static thermal stability of the chlorinated polyvinyl chlorides obtained in Examples 1 to 11 and Comparative Examples 1 and 2. In the above examples and comparative examples, the static thermal stability of the chlorinated polyvinyl chloride was evaluated by both an evaluation method A and an evaluation method B but maybe evaluated by one of the evaluation method A and the evaluation method B.

### [Static Thermal Stability]

10 parts by weight of methyl methacrylate-butadiene-styrene (MBS) resin, 2 parts by weight of a tin-based stabilizer, and 1.3 parts by weight of a lubricant were blended with 100 parts by weight of chlorinated polyvinyl chloride. This was kneaded at 190° C. for five minutes with an 8-inch roll to produce a sheet having a thickness of 0.6 mm. The sheet thus obtained was cut into a length of 3 cm and a width of 3.5 cm and then heated in an oven at 200° C. The time until the sheet was blackened was measured to evaluate the static thermal stability. In the evaluation method A, blackening was visually determined. In the evaluation method B, it is evaluated when the L value of the sheet becomes 22 or less. The L value was measured five times per sheet at 20° C. using a color difference meter (“Z-1001DP,” manufactured by Nippon Denshoku Industries Co, Ltd.) and the average value thereof was determined.

### [Vicat Softening Point and Izod Impact Strength]

8 parts by weight of methyl methacrylate-butadiene-styrene (MBS) resin, 2 parts by weight of a liquid tin-based stabilizer, and 1.3 parts by weight of a lubricant were blended with 100 parts by weight of chlorinated polyvinyl chloride. This was kneaded at 195° C. for five minutes with an 8-inch roll to produce a sheet having a thickness of 0.6 mm. Thereafter, 15 sheets thus obtained were superimposed on one another and then were pressed for ten minutes while the pressure was adjusted in the range of 3 to 5 MPa under a condition of 200° C. Thus a plate having a thickness of 5 mm was produced. Using the plate thus obtained as an evaluation sample, the Vicat softening point and Izod impact strength were measured as described below.

### <Vicat Softening Point>

Using the evaluation sample, the Vicat softening point of the chlorinated polyvinyl chloride was measured according to JIS K 7206. In this case, the load was set at 5 kg and the temperature rising rate was set at 50° C./h (the B50 method). The higher the Vicat softening point the better the heat resistance.

### <Izod Impact Strength>

Using the evaluation sample, the Izod impact strength of the chlorinated polyvinyl chloride was measured according to JIS K 7110. It was measured at 23° C. with a hammer of 2.75 J and a V notch put therein.

TABLE 1

| | | Irradiation | | UV | | | Irradiation | | | Static Thermal | | | |
|---|---|---|---|---|---|---|---|---|---|---|---|---|---|
| | | Intensity | UV | Light | UV | | Intensity | Supply | | Stability | | | |
| | | of UV | Light | Irradiation | Light | Reaction | of UV | Chlorine | Average | Eval- | Eval- | | |
| | Amount | Light | Irra- | Area | Irra- | Time of | Light | Gas | Chlorine | uation | uation | Izod | Vicat |
| | of PVC | per Unit | diation | per kg | diation | Chlorination | per kg | Concen- | Concen- | Method | Method | Impact | Softening |
| | Charged | Area | Area | of PVC | Time | Reaction | of PVC | tration | tration | A | B | Strength | Point |
| | kg | mW/cm² | cm² | cm² | min | min | W | vol % | vol % | min | min | kJ/m² | ° C. |
| Ex. 1 | 0.5 | 1 | 5 | 10 | 400 | 400 | 0.01 | 100 | 99.7 | 85 | 85 | 11.2 | 117.4 |
| Ex. 2 | 0.5 | 5 | 10 | 20 | 201 | 201 | 0.10 | 100 | 99.3 | 85 | 85 | 11 | 117.5 |
| Ex. 3 | 0.5 | 10 | 20 | 40 | 130 | 130 | 0.40 | 100 | 99.0 | 80 | 80 | 10.8 | 117.6 |
| Ex. 4 | 0.5 | 20 | 10 | 20 | 132 | 132 | 0.40 | 100 | 98.9 | 80 | 80 | 10.9 | 117.3 |
| Ex. 5 | 0.5 | 30 | 20 | 40 | 44 | 131 | 0.40 | 100 | 99 | 80 | 80 | 11 | 117.5 |
| Ex. 6 | 0.5 | 20 | 20 | 40 | 115 | 115 | 0.80 | 100 | 98.9 | 75 | 75 | 10.5 | 117.2 |
| Ex. 7 | 0.5 | 30 | 20 | 40 | 91 | 91 | 1.20 | 100 | 98.5 | 70 | 70 | 10.6 | 117.5 |
| Ex. 8 | 0.5 | 60 | 20 | 40 | 77 | 77 | 2.40 | 100 | 98.2 | 65 | 65 | 10.3 | 117.7 |
| Ex. 9 | 0.5 | 120 | 20 | 40 | 63 | 63 | 4.80 | 100 | 97.8 | 60 | 60 | 10.3 | 117.8 |
| Ex. 10 | 0.5 | 150 | 20 | 40 | 59 | 59 | 6.0 | 100 | 97.6 | 55 | 55 | 10 | 117.3 |
| Ex. 11 | 0.5 | 170 | 20 | 40 | 57 | 57 | 6.80 | 100 | 97.6 | 55 | 55 | 10.1 | 117.6 |
| Ex. 12 | 0.375 | 10 | 15 | 40 | 139 | 139 | 0.40 | 90 | 87.2 | 75 | 75 | 11 | 117.4 |
| Ex. 13 | 0.375 | 10 | 15 | 40 | 145 | 145 | 0.40 | 83 | 80.3 | 70 | 70 | 10.5 | 117.5 |
| Ex. 14 | 0.375 | 10 | 15 | 40 | 151 | 151 | 0.40 | 77 | 74.4 | 65 | 65 | 10.6 | 117.7 |
| Ex. 15 | 0.375 | 10 | 15 | 40 | 157 | 157 | 0.40 | 71 | 68.5 | 65 | 65 | 10.5 | 117.3 |
| Ex. 16 | 0.375 | 10 | 15 | 40 | 141 | 141 | 0.40 | 65→100 | 79.4 | 65 | 65 | 10.3 | 117.5 |
| Ex. 17 | 0.375 | 10 | 15 | 40 | 154 | 154 | 0.40 | 100→65 | 79.3 | 65 | 65 | 10.2 | 117.4 |
| Ex. 18 | 0.375 | 10 | 15 | 40 | 164 | 164 | 0.40 | 65 | 62.6 | 60 | 60 | 10 | 117.2 |
| Ex. 19 | 0.375 | 10 | 15 | 40 | 178 | 178 | 0.40 | 55 | 52.8 | 55 | 55 | 9.6 | 117.6 |
| Ex. 20 | 0.5 | 60 | 20 | 40 | 80 | 80 | 2.40 | 100 | 98.3 | 65 | 65 | 10.2 | 117.5 |
| C. Ex. 1 | 0.5 | 180 | 20 | 40 | 56 | 56 | 7.20 | 100 | 97.6 | 50 | 50 | 9.8 | 117.2 |
| C. Ex. 2 | 0.5 | 240 | 20 | 40 | 51 | 51 | 9.60 | 100 | 97.6 | 40 | 40 | 9.6 | 117.4 |
| C. Ex. 3 | 0.188 | 16.7 | 94.2 | 502 | 180 | 180 | 8.39 | 100 | 45.2 | 50 | 50 | 9.6 | 117.6 |
| C. Ex. 4 | 0.75 | 26.5 | 565 | 753 | 220 | 220 | 20.0 | 100 | 61.3 | 35 | 35 | 9.6 | 117.5 |

As can be seen horn the results shown in Table 1 and FIG. 2, in Examples 1 to 20, when the irradiation intensity of the UV light per kg of the polyvinyl chloride was set in the range of 0.0005 to 7.0 W, chlorinated polyvinyl chloride having a higher static thermal stability as compared to Comparative Examples 1 to 4 was obtained. Furthermore, when the irradiation intensity of the UV light per kg of the polyvinyl chloride was set in the range of 5.0 W or less the static thermal stability was improved. When the irradiation intensity of the UV light per kg of the polyvinyl chloride was set in the range of 2.5 W or less, the static thermal stability was further improved. When the irradiation intensity of the UV light per kg of the polyvinyl chloride was set in the range of 1.5 W or less, the static thermal stability was still further improved.

Furthermore, the chlorinated polyvinyl chlorides obtained in Examples 1 to 20 also had good. Izod impact properties. Moreover, as can be seen from the results of Examples 12 to 19, when the irradiation intensity of the UV light per kg of the polyvinyl chloride is the same, there is a tendency that the higher the average concentration, from the start time to the end time of the chlorination reaction, of the chlorine gas inside the reactor for performing the chlorination reaction, the better the static thermal stability of the resultant chlorinated polyvinyl chloride.

### DESCRIPTIONS OF REFERENCE NUMERALS

1 Fluidized Bed Reactor
2 Circulation Pump
3 Heat Transfer Tube
4 Nitrogen Supply Valve
5 Exhaust Valve
6 Chlorine Supply Valve
7 UV LED Light Source
8, 206, 305 Thermocouple
9 Internal Pressure Regulating Valve
10, 32, 42 Flowmeter
11, 202, 302 Polyvinyl chloride
20 Hydrogen Chloride Absorption Vessel
21 Electric Conductivity Meter
22 Water
23 Emission Gas
30 Chlorine Gas Cylinder
40 Nitrogen Gas Cylinder
50 Emitted Chlorine Gas
31, 41 Pressure Regulator
100, 110, 200, 300 Reaction Apparatus
201 Reactor (Eggplant-Shaped Flask)
203 Thermostat Tank
204 Stirrer
205, 304 High-Pressure Mercury Lamp
301 Reactor (Made of Hastelloy C22) 303 Temperature Control Jacket

Although the disclosure has been described with resect to only a limited number of embodiments, those skilled in the art, having benefit of this disclosure, will appreciate that various other embodiments may be devised without departing from the scope of the present invention. Accordingly the scope of the present invention should be limited only by the attached claims.

1. A method for producing chlorinated polyvinyl chloride, the method comprising;
placing polyvinyl chloride in a powder form in a reactor;
introducing chlorine gas into the reactor, wherein the chlorine gas is brought into contact with the polyvinyl chloride; and
irradiating the polyvinyl chloride with UV light,
wherein the UV light has a wavelength ranging from 280 to 420 nm and an irradiation intensity in a range of 0.0005 to 7.0 W per kg of the polyvinyl chloride,
an average concentration, from a start time to an end time of a chlorination reaction, of the chlorine gas inside the reactor is 50% or more, and
the reactor is a fluidized bed reactor.

2. The method of claim 1, wherein the average concentration, from a start time to an end time of a chlorination reaction, of the chlorine gas inside the reactor is 65% or more.

3. The method of claim 1, wherein the average concentration, from a start time to an end time of a chlorination reaction, of the chlorine gas inside the reactor is 80% or more.

4. The method of claim 1, wherein the average concentration, from a start time to an end time of a chlorination reaction, of the chlorine gas inside the reactor is 85% or more.

5. The method of claim 1, wherein the average concentration, from a start time to an end time of a chlorination reaction, of the chlorine gas inside the reactor is 90% or more.

6. The method of claim 1, wherein the average concentration, from a start time to an end time of a chlorination reaction, of the chlorine gas inside the reactor is 95% or more.

7. The method of claim 1, wherein the polyvinyl chloride has a mean particle size of 25 to 2500 μm.

8. The method of claim 2, wherein the polyvinyl chloride has a mean particle size of 25 to 2500 μm.

9. The method of claim 3, wherein the polyvinyl chloride has a mean particle size of 25 to 2500 μm.

10. The method of claim 4, wherein the polyvinyl chloride has a mean particle size of 25 to 2500 μm.

11. The method of claim 5, wherein the polyvinyl chloride has a mean particle size of 25 to 2500 μm.

12. The method of claim 6, wherein the polyvinyl chloride has a mean particle size of 25 to 2500 μm.

13. The method of claim 1, wherein the irradiation with the UV light is performed using at least one light source selected from the group consisting of a low-pressure mercury lamp, a high-pressure mercury lamp, a metal halide lamp, a UV LED, an organic EL, and an inorganic EL.

14. The method of claim 2, wherein the irradiation with the UV light is performed using at least one light sonar selected from the group consisting of a low-pressure mercury lamp, a high-pressure mercury lamp, a metal halide lamp, a UV LED, an organic EL, and an inorganic EL.

15. The method of claim 3, wherein the irradiation with the UV light is performed using at least one light source selected from the group consisting of a low-pressure mercury lamp, a high-pressure mercury lamp, a metal halide lamp, a UV LED, an organic EL and an inorganic EL.

16. The method of claim 4 wherein the irradiation with the UV light is performed using at least one light source selected horn the group consisting of a low-pressure mercury lamp, a high-pressure mercury lamp, a metal halide lamp, a UV LED, an organic EL, and an inorganic EL.

17. The method of claim 5, wherein the irradiation with the UV light is performed using at least one light source selected from the group consisting of a low-pressure mercury lamp, a high-pressure lamp, a metal halide lamp, a UV LED, an organic EL, and an inorganic EL.

18. The method of claim 6, wherein the irradiation with the UV light is performed using at least one light source selected from the group consisting of a low-pressure mercury lamp, a high-pressure mercury lamp, a metal halide lamp, a UV LED, an organic EL, and an inorganic EL.
